(19) United States
(12) Patent Application Publication
(10) Pub. No.: US 2015/0090094 A1
(43) Pub. Date: Apr. 2, 2015

(54) Pipe Peeler

(71) Applicant: REED MANUFACTURING COMPANY, Erie, PA (US)

(72) Inventors: Christopher M. Arkwright, Erie, PA (US); Robert M. Sterner, Erie, PA (US)

(73) Assignee: REED MANUFACTURING COMPANY, Erie, PA (US)

(21) Appl. No.: 14/229,848

(22) Filed: Mar. 29, 2014

Related U.S. Application Data
(63) Continuation-in-part of application No. 13/289,670, filed on Nov. 4, 2011, now Pat. No. 8,720,070.

(51) Int. Cl. B23D 79/12; B26D 3/28; B26D 3/16

(52) U.S. Cl. CPC B23D 79/12; B26D 3/16; B26D 3/282
USPC 83/870; 30/100

(57) ABSTRACT

A pipe peeler for removing a uniform layer of material from the outer surface of a polyethylene pipe is provided. The device comprises a body, a blade, a chain coupled near a first face of the body, a means for coupling the other end of the chain to the body near a second face of the body, a means for tightening the chain around a pipe, and a grip for rotating the device around the pipe in order to peel the pipe. The chain may define a helix shape when wrapped around the pipe, creating a spiral track on the pipe that the blade will follow when the device is pushed around the pipe, thereby creating a uniform spiral peel.

This application is a continuation-in-part of application Ser. No. 13/289,670, filed Nov. 4, 2011.

### BACKGROUND

This invention relates to pipe preparing tools, and more particularly to novel devices for peeling the outer surface of a polyethylene pipe, even when the outside of the pipe does not have a perfectly circular circumference or uniform diameter.

It is often necessary to remove a portion of the exterior surface of a pipe prior to welding or otherwise affixing the pipe to a coupling. In an electrofusion process for joining plastic pipes, such as those constructed of polyethylene, it is an absolute requirement. Removal of a portion of the exterior surface of the pipe eliminates oxidation of and impurities in the exterior surface of the pipe, and helps ensure a trouble-free joint.

Uniform peeling of polyethylene pipes can be a difficult task because the pipes are often already “in the field” and affixed in place, thereby limiting the use of larger, more precise pipe peeling machines. Under these circumstances, a uniform peel can be difficult to achieve. Many pipe peelers require multiple attachments, often to the inside of the pipe being peeled, which lengthens the time required to peel the pipe.

It is an object of the present disclosure to provide a pipe peeler that will create a uniform peel on the end of a polyethylene pipe.

It is an object of the present disclosure to provide a pipe peeler that will peel in a spiral pattern on the outer surface of a polyethylene pipe.

It is an object of the present disclosure to provide a pipe peeler that does not require itself to be anchored to the inside of a pipe for use.

It is another object of the present disclosure to provide a pipe peeler that has no delicate or easily breakable exposed parts and requires minimal or no cleaning.

It is another object of the present disclosure to provide a pipe peeler that is small, compactable, and lightweight.

It is another object of the present disclosure to provide a single pipe peeler that may be used on a wide range of pipe circumferences.

It is another object of the present disclosure to provide a pipe peeler that can peel a circular or oval pipe.

It is another object of the present disclosure to provide a pipe peeler that can easily be used “in the field” on an immovable pipe.

It is another object of the present disclosure to provide a pipe peeler whereby a user can release his or her grip on the peeler and the peeler will remain in place on the pipe.

It is another objected of the present disclosure to provide a pipe peeler that can operate on pipes that do not have perfectly circular outer circumferences or uniform diameters.

Various other features, advantages and characteristics of the present invention will become apparent to one of ordinary skill in the art after a reading of the following specification.

In the displayed embodiments, the pipe peeler comprises a cuboid body, a retractable blade, a chain, means for coupling the chain near the front and back of the body, a means for pulling one end of the chain towards the body (and thereby tightening the chain around a pipe), and a grip. The two connection points of the coupling the chain to the body are offset so that the chain forms a helix when the chain is tightened around a pipe.

As used herein, the term “chain” is meant to include other devices which may encircle a pipe, including but not limited to cables, belts, cords, ropes, harnesses, clamps, and so on.

As used herein, the term “chain segment” may to refer to less than an entire chain or the entire chain as disclosed in the specification and claims.

The particular embodiments described below are proven to uniformly peel polyethylene pipe. However, these embodiments and obvious modifications thereof may also uniformly peel pipes with material properties similar to polyethylene. This disclosure and the claims herein are directed toward peelers for pipe with material properties similar to polyethylene.

### BRIEF DESCRIPTION OF THE DRAWINGS

FIG. 1 is a side perspective view of some parts of an embodiment of the invention, with some parts omitted in order to provide a clear view of the parts shown therein;

FIG. 2A is a side view of the parts of the embodiment of FIG. 1;

FIG. 2B is a top view of the parts of the embodiment of FIG. 1;

FIG. 2C is a front view of the parts of the embodiment of FIG. 1;

FIG. 3A is a side view of the complete embodiment of the invention, in use on a pipe;

FIG. 3B is a side perspective view of the embodiment of FIG. 3A;

FIG. 3C is a side perspective view of the embodiment of FIG. 3A;

FIG. 4A is a top view of the embodiment of FIG. 3A;

FIG. 4B is a rear view of the embodiment of FIG. 3A;

FIG. 4C is a front view of the embodiment of FIG. 3A;

FIG. 5 is an exploded view of a portion of the embodiment shown in FIGS. 3A-3C;

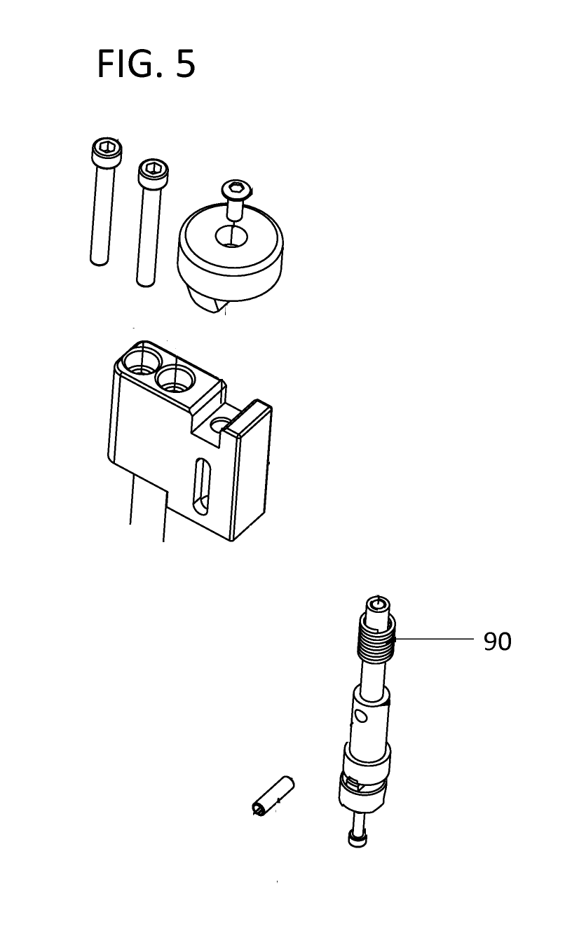

FIG. 6A is an exploded view of a second embodiment of the invention;

FIG. 6B is identical to 6A but identifies additional elements of the second embodiment;

FIG. 7 is a side cross-section view of the second embodiment of FIGS. 6A and 6B;

FIG. 8 is a top view of the second embodiment of FIGS. 6A and 6B, in use on a pipe.

FIG. 9 is a rear view of the second embodiment of FIGS. 6A and 6B, in use on a pipe.

### DESCRIPTION OF EMBODIMENTS

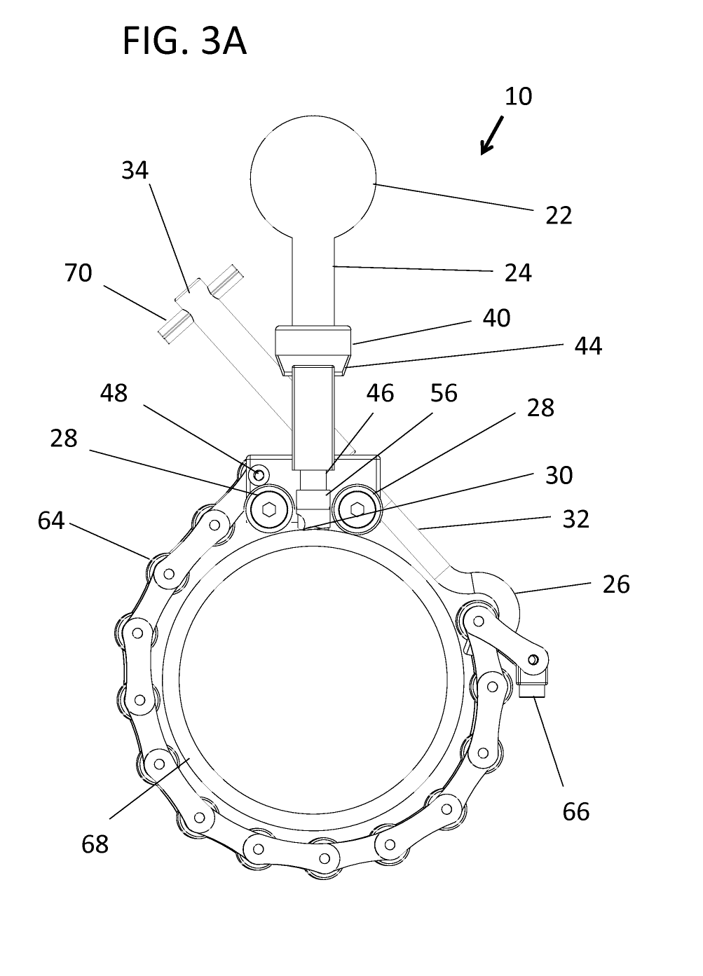

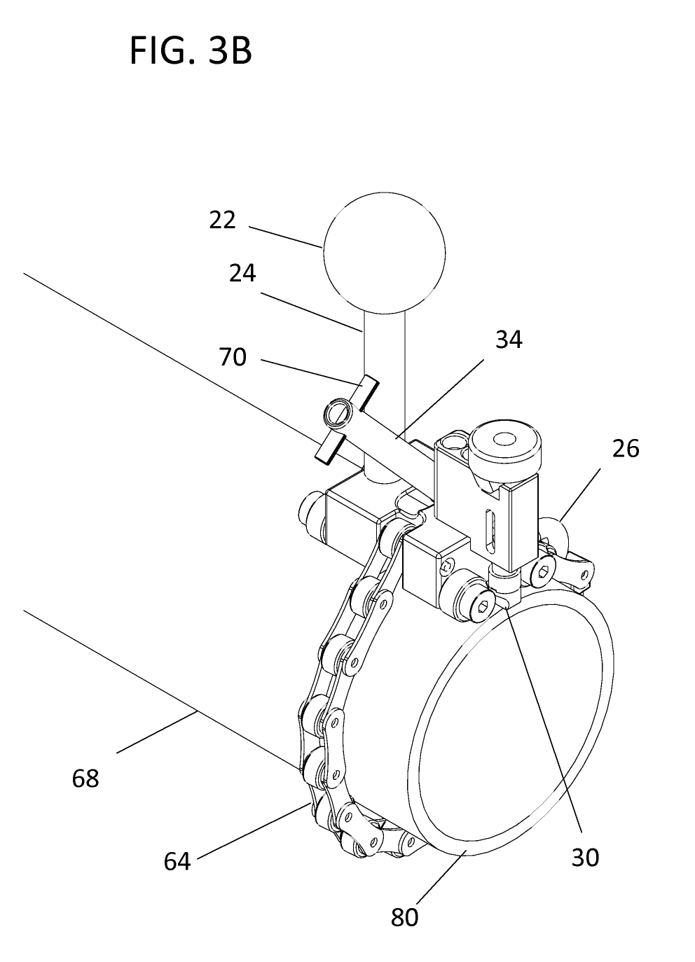

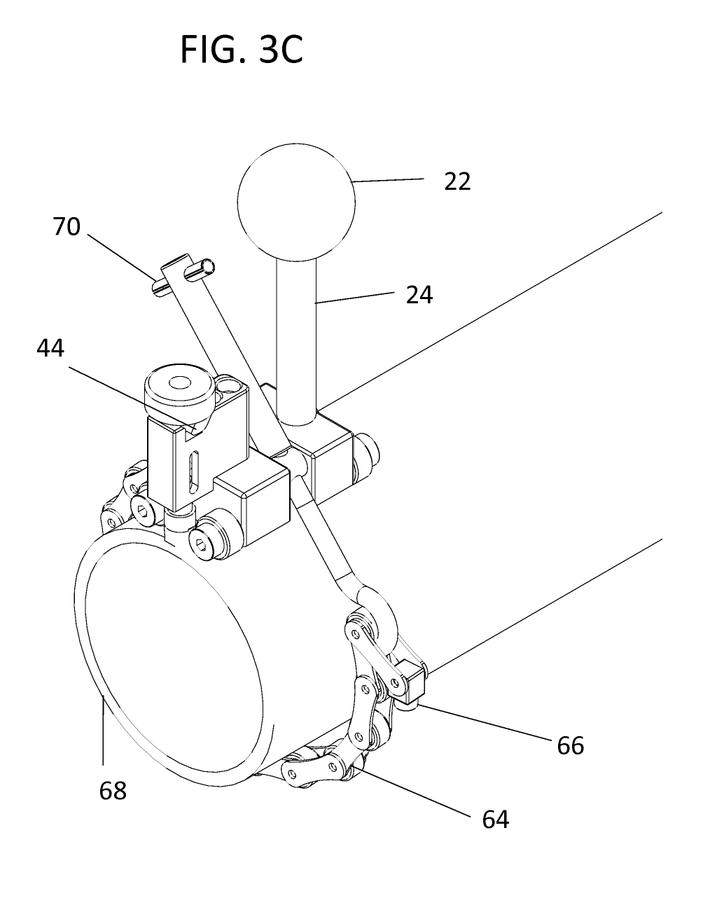

An embodiment of the pipe peeler surrounding a pipe is shown in FIGS. 3A, 3B, and 3C generally at 10. In all embodiments disclosed, substantially all parts of the pipe peeler may be made of metal but are interchangeable with other materials obvious to those skilled in the art.

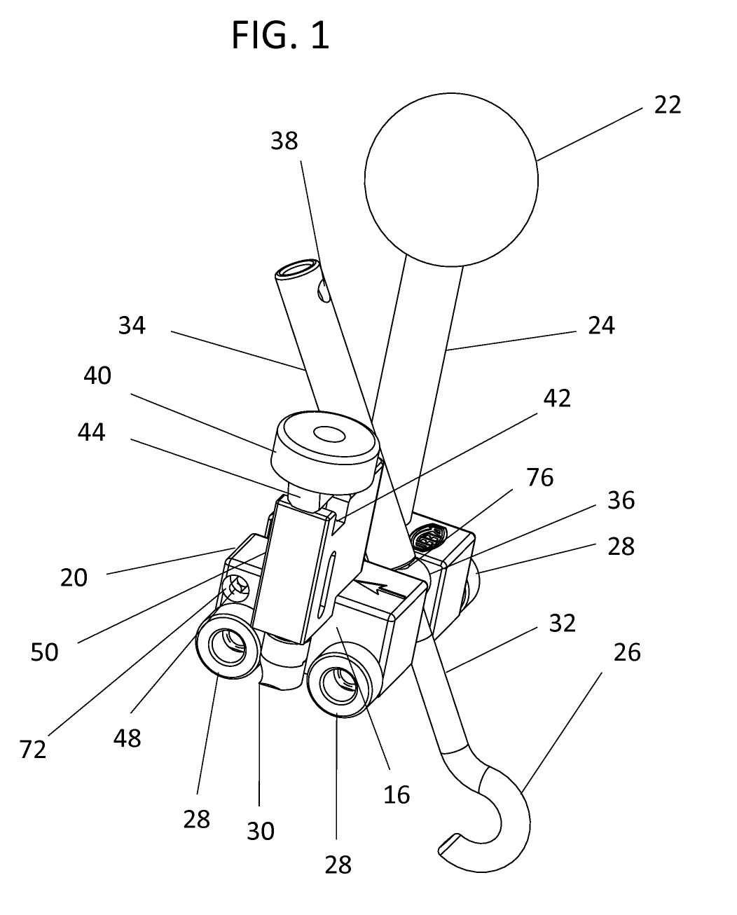

Referring to FIG. 1, the pipe peeler 10 includes a peeler body 20. In this embodiment, peeler body 20 is generally cuboid-shaped but other embodiments may take other shapes without adverse effect on the device's functionality.

Four wheels 28 are attached to the peeler body 20. The wheels 28 can be bolted or otherwise affixed to the body 20 and each wheel 28 may rotate about a shoulder bolt.

Grip shaft 24 is affixed to peeler top face 18, wherein the affixing may be done by a male thread (not shown) on the grip shaft 24 and female thread (not shown) in the peeler body 20, or other affixing means such as welding or manufacturing the peeler body 20 and grip shaft 24 in one piece. Likewise, grip knob 22 is affixed to grip shaft 24, using, for example a male thread (not shown) on the grip shaft and a female thread (not shown) in the grip knob, or other means such as welding or manufacturing the knob 22 and shaft 24 as one piece.

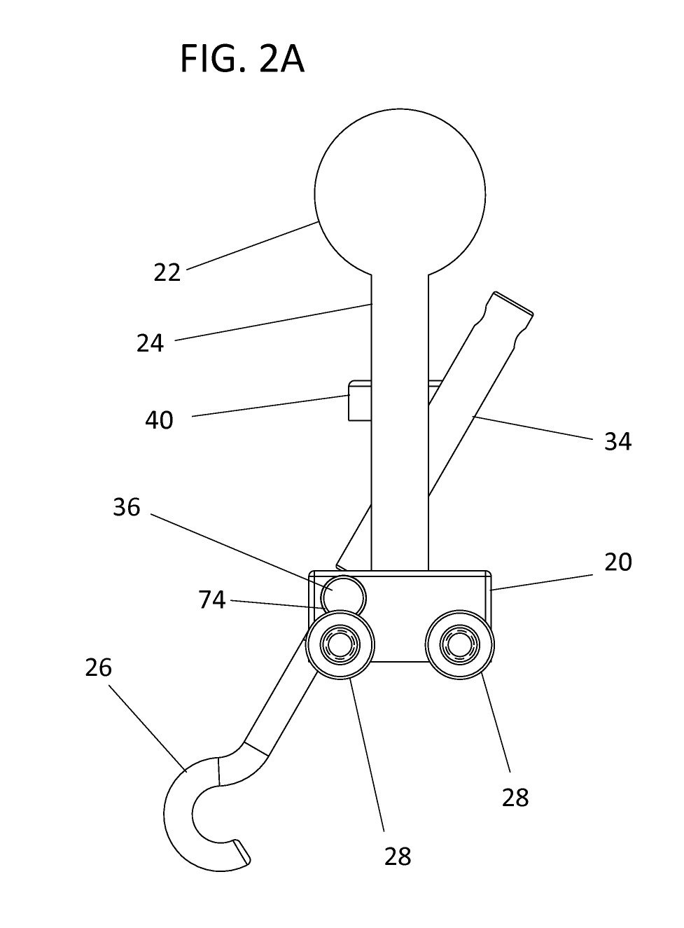

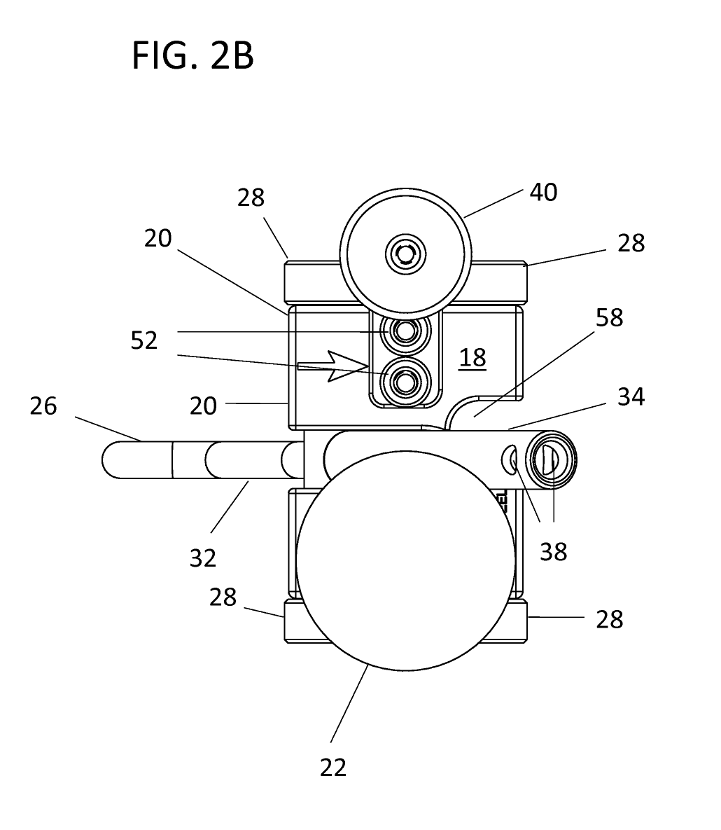

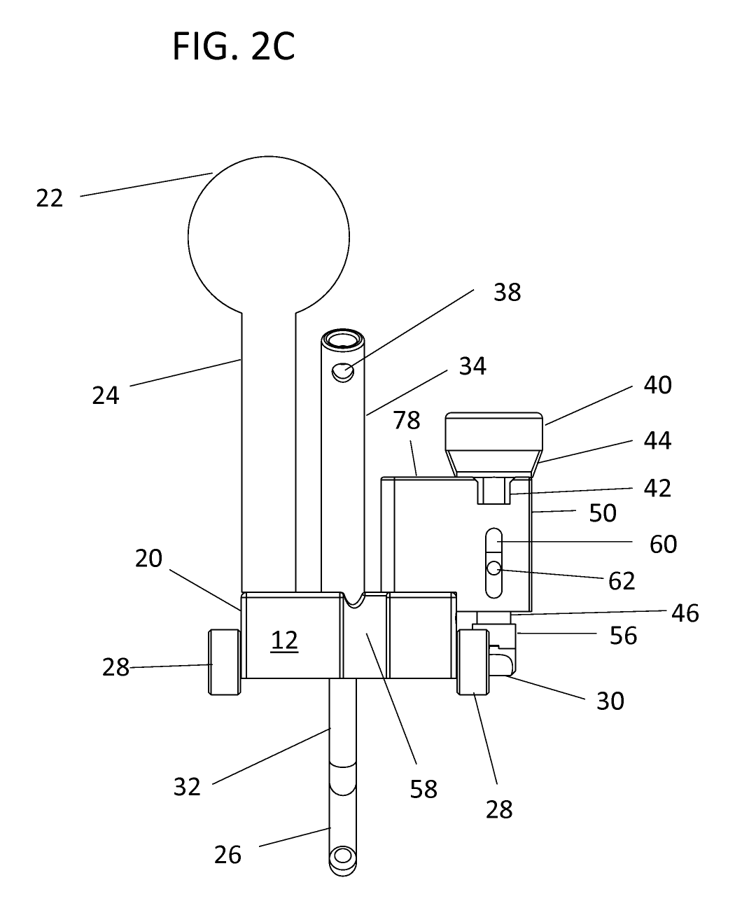

As shown in FIG. 2B, peeler front face 12 includes a holding pin recess 58. Holding pin 48 is affixed inside holding pin recess 58 and is parallel to peeler front face 12. As seen in FIG. 1, one end of holding pin 48 is inside holding pin aperture 72, while the other end of holding pin 48 may be affixed to the holding pin recess 58 wall opposite holding pin aperture 72 using, for example, a male thread (not shown) on the holding pin end and a receiving female thread (not shown) on holding pin recess 58 wall opposite the holding pin aperture 72, with, for example, a flathead screwdriver receptor or hex key receptor at the end of the holding pin 48 that is exposed on peeler blade face 16 through holding pin aperture 72. An alternative to this drawn embodiment is, for example, welding the holding pin 48 in place. The holding pin 48 does not need to be able to rotate when the pipe peeler 10 is in use.

Peeler back face 14 includes a pivot bar recess 54. Pivot bar 36 is inside pivot bar recess 54 and is parallel to peeler back face 14. One end of pivot bar 36 is inside pivot bar aperture 74, while the other end of pivot bar is inside a recess (not shown) on pivot bar recess 54 wall opposite pivot bar aperture 74. As shown in FIG. 2A, one of the wheels 28 holds pivot bar 36 in place. Pivot bar 36 should be able to rotate when the pipe peeler 10 is in use.

Threaded hook shaft 32 goes through hook pivot aperture 76. Female threaded cylinder 34 affixes to threaded hook shaft 32. Threaded hook shaft is connected to, or manufactured as one piece with, hook 26. Cylinder handle 70 is in female threaded cylinder 34 through cylinder apertures 38. In this embodiment, cylinder handle 70 is held in place inside female threaded cylinder 34 with spring resistance and friction, but may be held in place using other means such as, for example, welding or manufacturing the female threaded cylinder 34 and cylinder handle 70 as one piece.

Blade body 50 is affixed to peeler body 20 with two blade body bolts 52 threaded through two female threaded receptors (not shown) on peeler top face 18. Alternatively, blade body 50 may be affixed to peeler body 20 with welding or other means obvious to those skilled in the art.

Blade shaft 46 goes through blade body 50 through a cylindrical aperture (not shown) in blade body 46. Blade shaft 46 is attached to blade knob projection 44. Blade knob projection is attached to blade knob 40. The opposite end of blade shaft 46 is attached to blade stop 56. Blade stop 56 is attached to blade 30. Alternatively, both blade 30 and blade stop 56 may be attached to blade shaft 46 directly with, for example, a male thread on blade shaft 46 and female threads in blade stop 56 and blade 30.

Blade stabilizing pin 62 is affixed to blade shaft 46. Inside blade body 50 a compressed spring 90 pushes against blade stabilizing pin 62 such that the natural tendency of the spring 90 is to push blade stop 56 and blade 30 away from blade body 50. The compressed spring 90 may surround blade shaft 46.

Blade stabilizing pin 62 may move along the major axis of blade stabilizing elliptical opening 60, allowing blade 30 to be in a raised or lowered position. However, blade stabilizing pin may not move on the minor axis of blade stabilizing elliptical opening 60, thereby preventing blade shaft 46 and blade 30 from rotating.

As shown in FIG. 2C, when blade knob projection 44 presses against blade body top face 78, blade 30 does not extend downward beyond wheels 28. As shown in FIG. 3B, when blade knob projection 44 is in blade body notch 42, blade 30 is fully extended and may extend beyond wheels 28 and press against a pipe 68. Thus, blade 30 may be raised by turning blade knob 40 clockwise and lowered by turning blade knob 40 counterclockwise.

Before wrapping chain 64 around a pipe 68, blade 30 is in raised position, i.e., blade knob extension 44 is resting against blade body top face 78.

Turning now to FIGS. 3A, 3B, and 3C, one end of a chain 64 is attached to peeler body 20. Chain 64 is wrapped around a pipe 68, and hook 26 threads through chain 64 at a point that enables chain 64 to wrap as tightly as possible around pipe 68. As seen in FIG. 3B, at this point pipe peeler 10 may be positioned on pipe 68 such that blade 30 is positioned over the pipe end 80 to be peeled.

Chain 64 is further tightened by turning cylinder handle 70, thereby pulling threaded hook shaft 32 and hook 26 into female threaded cylinder 34 and pulling chain 64 toward peeler body 20. Tightening is continued until pipe peeler 10 is immobile on pipe 68 and will not slide off of pipe even when pipe peeler 10 is not being held by a user.

If the length of chain 64 is much larger that pipe 68 circumference and the part of chain 64 not being used extends far beyond point at which hook 26 threads through chain, a magnet 66 at end of chain 64 will attach excess loose chain 64 to chain 64 surrounding pipe 68.

Once chain 64 is fully tightened around pipe 68, blade knob 40 may be turned such that blade projection 44 rests in blade body notch 42 thereby allowing blade 30 to extend downward and contact pipe, as seen in FIG. 3B.

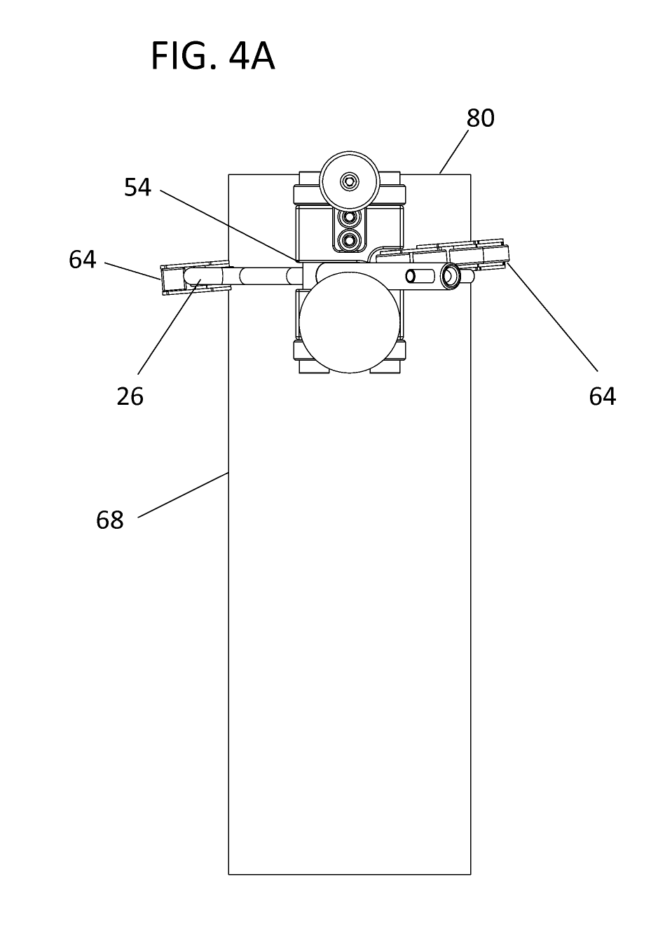

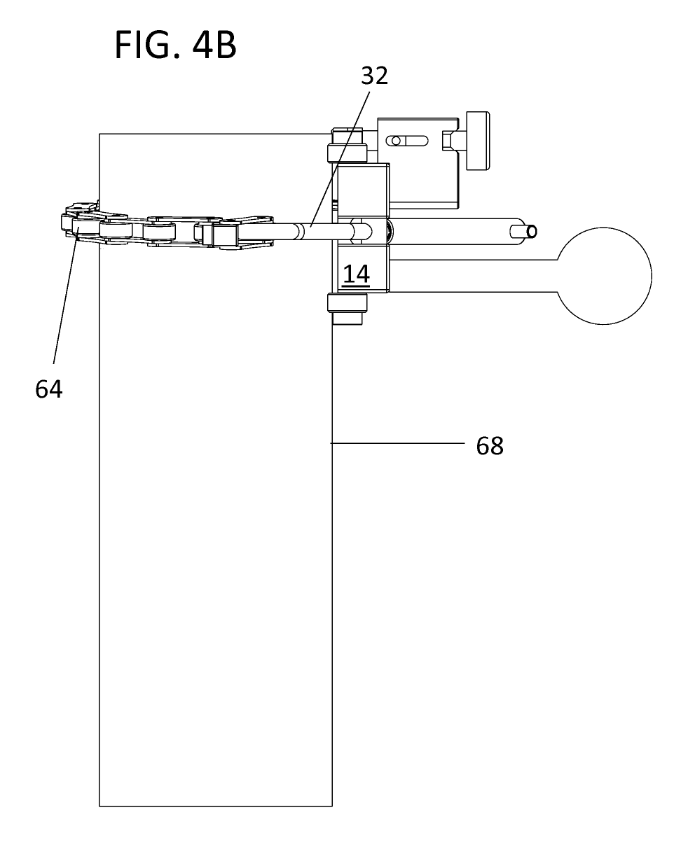

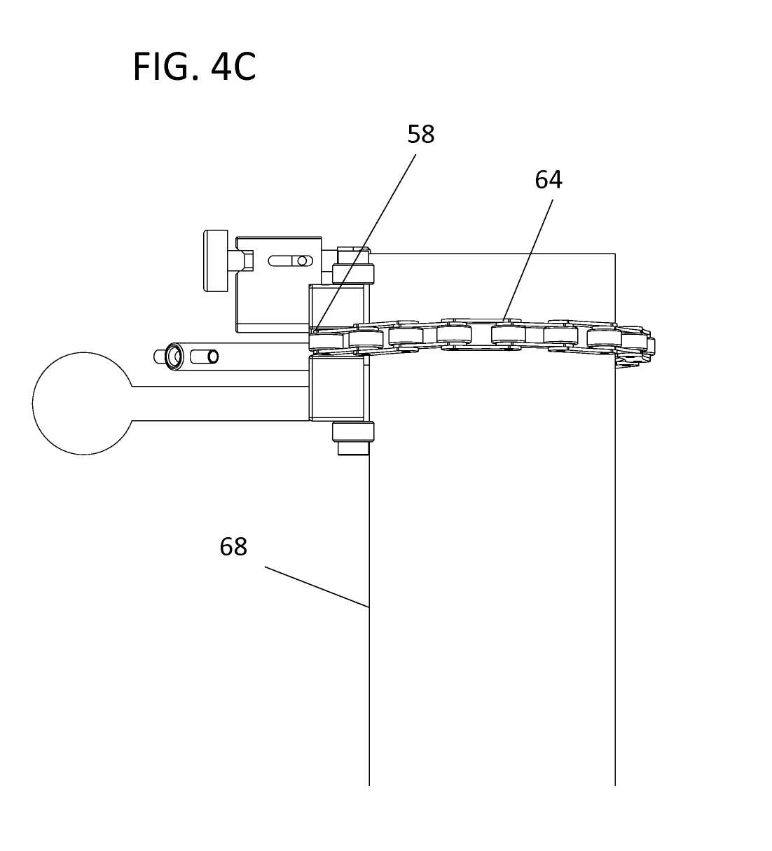

As shown in FIG. 4A, chain 64 is slightly offset where the chain end connected to holding pin 48 is closer to pipe end 80 and the chain point connected to hook 26 is slightly farther away from pipe end 80.

Once chain 64 is fully tightened and blade 30 is extended to press against pipe 68, grip knob 22 is pushed in a direction tangential to pipe circumference, toward peeler front face 12, such that pipe peeler 10 rotates around pipe 68 thereby allowing blade 30 to peel the outer surface of the pipe 68.

Due to the slightly giving and springy nature of polyethylene pipe, the pressure of the chain 64 against the pipe 68 will cause the chain 64 to press a temporary “track” into in the pipe 68. As pipe peeler 10 is rotated around pipe 68, the chain 64 “track” will direct the pipe peeler 10 to move down the pipe 68 in a uniform spiral, thereby allowing the blade 30 to create a uniform peel. The chain leaves none, or very minimal, permanent “track” on the pipe.

In this embodiment, the width of the blade 30 is greater than the helical pitch, i.e., greater than the distance that the pipe peeler 10 travels away from the pipe end 80 during one full rotation of the pipe peeler 10 around the pipe 68.

Once the pipe 68 has been peeled a satisfactory amount, blade knob 40 may be turned clockwise to raise blade 30. Cylinder handle 70 is turned to allow hook 26 to move away from female threaded cylinder 34, thereby allowing chain 64 to loosen and enabling pipe peeler 10 to be removed from pipe 68.

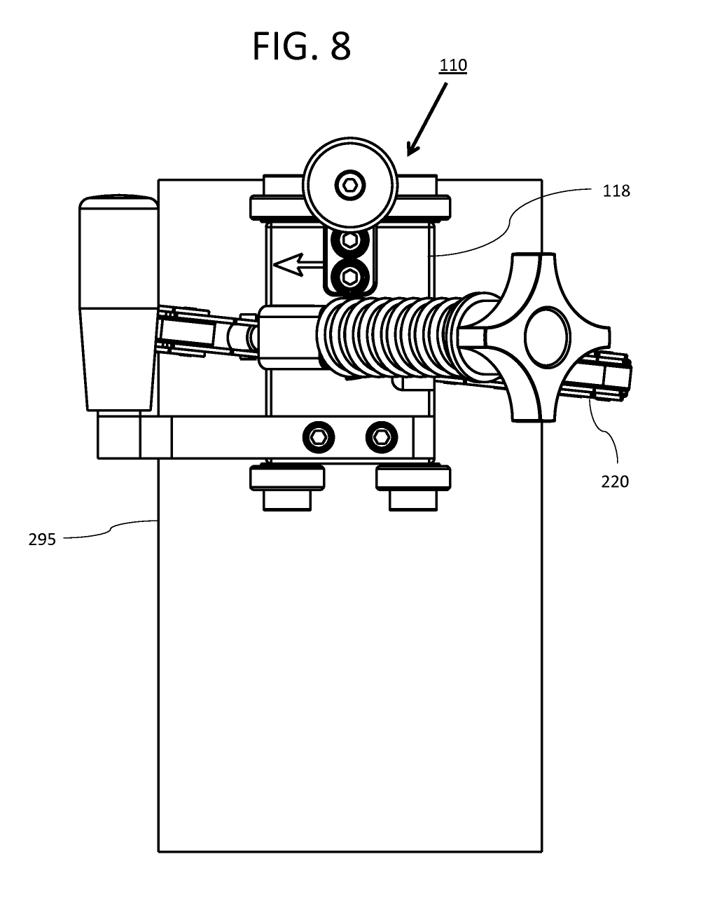

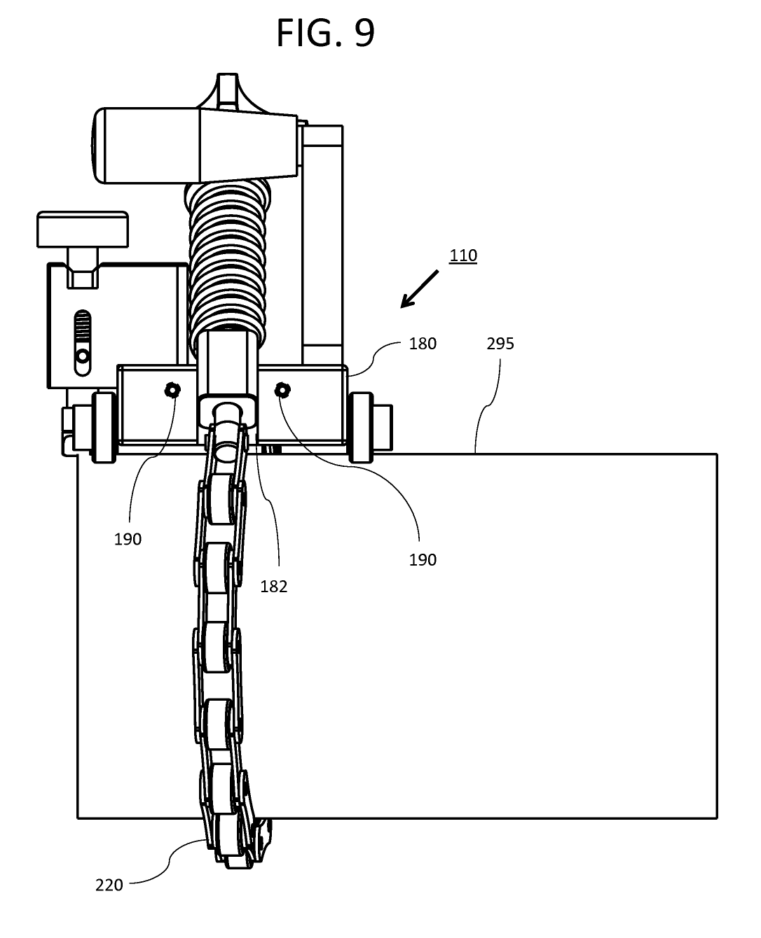

A second embodiment of a pipe peeler 110 surrounding a pipe is shown in FIGS. 8 and 9. In this embodiment substantially all of the parts may be made of metal but are interchangeable with other materials obvious to those skilled in the art. While this second embodiment functions substantially similarly to the first embodiment discussed above, the second embodiment also includes, among other things, a tensioner 200 with spring 210, that increases the peeler's ability to peel non-uniform pipe surfaces, e.g., where the pipe does not have a perfectly circular circumference.

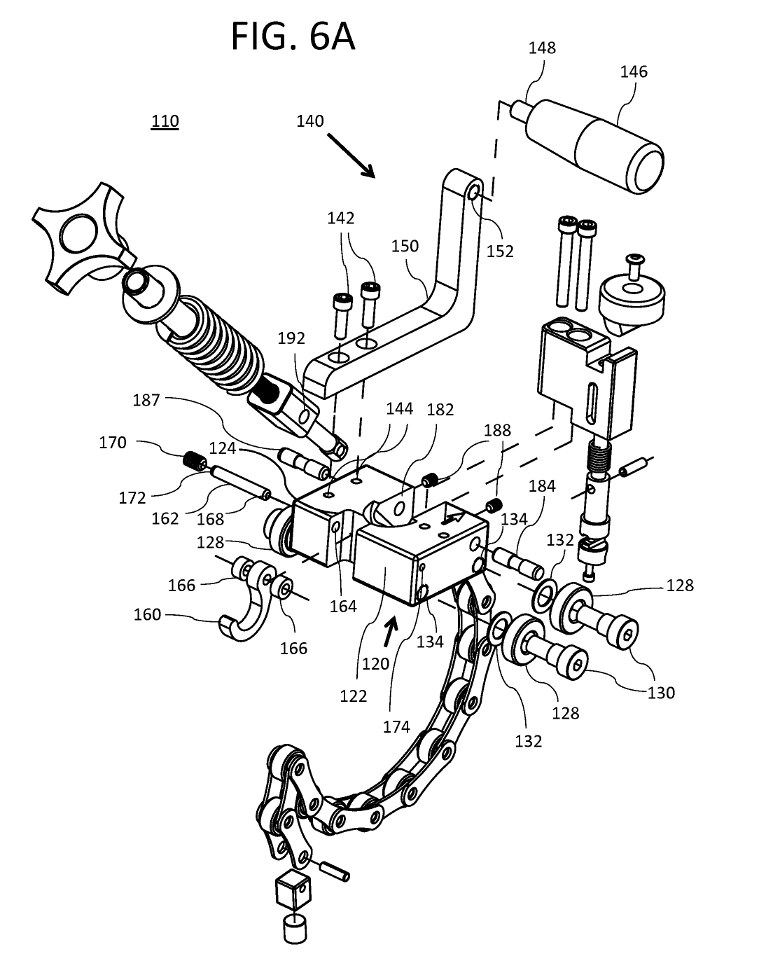

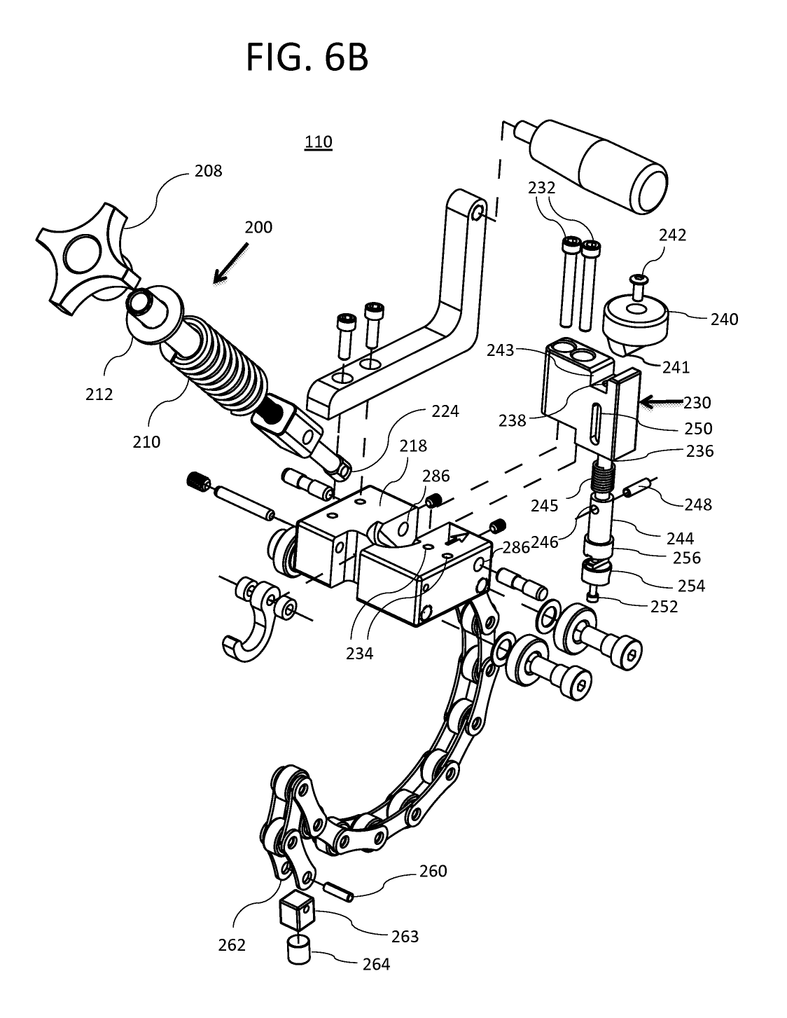

Referring to FIG. 6A, the second embodiment pipe peeler 110 includes a peeler body 120 which is generally cuboid-shaped; however, other embodiments may take other shapes without adverse effect on the device's functionality.

In this embodiment four wheels 128 are attached to peeler body 120 by attaching wheel bolts 130 to recesses 134 which are threaded (not shown) to receive wheel bolts 130. Wheels 128 are sandwiched between wheel washers 132 and wheel bolts 130. The wheels 128 may, for example, include internal ball bearings (not shown) that allow the outer rims of the wheels 128 to rotate while the remainder of each of the wheels 128 are in fixed positions relative to the peeler body 120.

Grip 140 is affixed to peeler body 120 by screwing in grip bolts 142 to recesses 144 which are threaded (not shown) to receive grip bolts 142, thereby securing grip body 150 flush with peeler body 120. Grip knob 146 includes threaded end 148 that affixes to threaded (not shown) recess 152 in grip body 150. Of course, a grip body and grip knob may be affixed to the peeler body by other means, for example welding, or manufacturing the peeler and grip as one piece.

As shown in FIG. 6A, peeler front face 122 includes a front recess 124. Hook 160 and side washers 166 are secured to peeler body 120 with holding pin 162 that passes through peeler body aperture 164, hook 160, and side washers 166. Distal beveled pin end 168 lodges into matching-size recess (not shown) opposite aperture 164. Proximal beveled pin end 172 fits into set screw 170, which is screwed into threaded (not shown) outer portion of aperture 164, thereby securing holding pin 162. Note that hook 160 may pivot on holding pin 162. Release aperture 174 is a smaller diameter than the holding pin 162 and is used as an access hole to push out the holding pin 162 if needed.

Peeler back face 180 (see, e.g., FIG. 9) includes a back recess 182. Holding pins 184 extend into recess 182 through respective apertures 286 and are held in place in apertures 286 by set screws 188 threaded into threaded (not shown) apertures 190 located on peeler back face 180. Holding pins 184 fit into pivot block recesses 192.

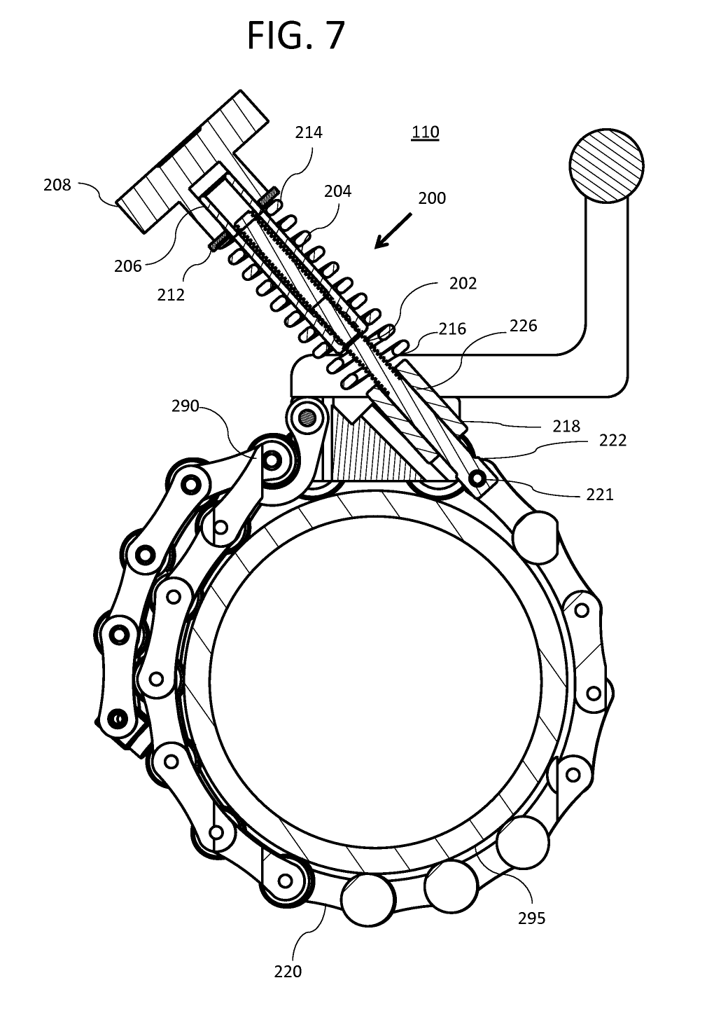

FIG. 7 shows a tensioner 200 cross-section. Tensioner 200 includes an inner shaft 202 with male threads that fit to the female threads of an outer shaft 204. Outer shaft 204 also includes male threads 206 that fit to the female threads of knob 208. Disc 212 is between knob 208 and upper end 214 of spring 210. Lower end 216 of spring may rest against pivot block 218, and inner shaft 202 goes through pivot block aperture 226.

A pin 221 included near first end 222 of chain 220 is affixed to inner shaft 202 through inner shaft aperture 224.

Blade body 230 is affixed to peeler body 120 with two blade body bolts 232 screwed into threaded apertures 234 on peeler top face 118 (see FIG. 8). Alternatively, blade body 230 may be affixed to peeler body 120 with welding or other means obvious to those skilled in the art.

Blade shaft 236 goes through blade body 230 through cylindrical aperture 238. Blade shaft 236 is affixed to blade stop 240 with barrel nut 242 that screws onto corresponding male threads (not shown) on blade shaft 236.

Spring 245 on blade shaft 236 is located between blade stop 240 and cylinder 244. Cylinder 244 includes aperture 246 through which a stabilizing pin 248 is affixed. Bolt 252 affixes blade 254 and blade stop 256 to cylinder 244.

Stabilizing pin 248 may move along the major axis of elliptical opening 250, allowing blade 254 to be in a raised or lowered position. However, stabilizing pin 248 may not move on the minor axis of elliptical opening 250, and therefore blade shaft 236 and blade 254 may not rotate.

Second end 262 of chain 220 is affixed to block 263 and magnet 264 with chain pin 260.

FIGS. 8 and 9 display this second embodiment with the chain 220 wrapped around a pipe 295. A first location 221 (e.g., near first end 222) on chain 220 is coupled to peeler body 120 near peeler back face 180 via tensioner 200. Chain 220 is wrapped snugly around pipe 295, and second location 290 on chain 220 is coupled to peeler body 120 near peeler front face 122 via hook 160.

Knob 208 is turned clockwise, thereby threading outer shaft 204 with inner shaft 202 and initially pulling outer shaft 204 (and thus knob 208 and disc 212) toward chain first location 260. However, turning the knob 208 clockwise eventually presses disc 212 against spring 210, such that spring 210 is compressed between disc 212 and pivot block 218, which act as stoppers for spring 210. Thus, further threading of outer shaft 204 with inner shaft 202 will cause inner shaft 202 to pull upwards toward knob 208 thus tightening chain 220 around pipe 295. (Of course, tightening chain 220 will also cause additional compression to spring 210.) Chain 220 should be sufficiently snug around pipe 295 such that the device will not slide off the pipe even when the device is not being held by a user, but for optimal use 220 should not be tightened to the point where spring 210 is completely compressed.

If the length of chain 220 is much larger that pipe 295 circumference and the part of chain 220 not being used extends far beyond point at which hook 160 couples to chain second location 290, the magnet 264 will attach excess loose chain to the chain surrounding the pipe.

Once chain 220 is fully tightened around pipe 295, blade stop 240 may be turned such that projection 241 rests in blade body notch 243 thereby allowing blade 254 to extend downward and contact pipe.

Back recess 182 is offset from front recess 124, resulting in second chain location 290 at hook 160 being offset from first chain location 221/222. As a result, as seen in FIGS. 8 and 9, the chain between first chain location 221/222 and second chain location 290 forms a helix shape when this portion of the chain is made into an arc, e.g., when it is wrapped around a pipe. (The amount of offset helps determine the helical angle of the chain 220 secured around a pipe 295.)

The embodiment shown in FIGS. 6A-9 is optimal for use where the pipe to be peeled is not perfectly circular, for example, is oval, or is deformed, or changes diameter along its length. Where more “give” is required on chain 220 because a portion of the peeling path is not perfectly circular, spring 210 may compress, thereby allowing chain 220 at first chain location 221/222 to move away from peeler back face 180. Likewise, where the peeling path may ordinarily result in slack on the chain 220, spring 210 may expand, thus pulling first chain location 221/222 toward peeler back face 180.

Of course, where the pipe being shaved does not have a uniform circular circumference or constant diameter, the chain likewise may not define a perfect circular helix, even though the tightened chain between first and second locations 260, 190 will still be substantially helix-shaped. For example, an elliptical pipe may result in the chain defining an elliptical helix, a cone-shape pipe may result in the chain defining a conic helix, a pipe with a bulge may still result in the chain being substantially helical, and so on.

Various changes, alternatives, and modifications will become apparent to a person of ordinary skill in the art after a reading of the foregoing specification. It is intended that all such changes, alternatives, and modifications as fall within the scope of the appended claims be considered part of the present invention.

We claim:

1. A device for peeling a pipe, comprising:
(A) a body that includes a first face and a second face;
(B) a blade coupled to said body;
(C) a chain segment, wherein said chain segment includes a first attachment location on a chain segment first end and a second attachment location on a chain segment second end;
(D) a first coupler, wherein said first coupler is operable to couple said first attachment location to said body near said first face;
(E) a tightener, wherein
(a) said tightener includes a second coupler, wherein said second coupler is operable to couple said second attachment location to said body near said second face, and
(b) said tightener is operable to reduce a distance between said second attachment location and said second face when said second attachment location is coupled to said second coupler;
wherein said chain segment substantially defines a helix when
(a) said first attachment location is coupled to said first coupler,
(b) said second attachment location is coupled to said second coupler, and
(c) said chain segment is positioned as an arc.

2. The device of claim 1, further comprising a grip affixed to said body.

3. A method for peeling a helical pattern on a pipe, comprising:
(A) coupling a blade to a body;
(B) coupling a first end of a chain segment to said body;
(C) placing a bottom face of said body proximate to a pipe;
(D) wrapping said chain segment around said pipe;
(E) coupling a second end of said chain segment to said body;
(F) tightening said chain segment around said pipe such that said chain segment substantially defines a helix;
(G) placing said blade in contact with said pipe;
(H) pushing said body around said pipe, such that said blade peels a substantially helical pattern on the outside of said pipe.

4. The method of claim 3, further comprising coupling a spring to said first end and said body, such that when said chain segment is tightened around said pipe, said spring is
(A) operable to compress when additional force is added pulling said first end away from said body and
(B) operable to expand when the force pulling said first end from said body is decreased.

5. The method of claim 3, further comprising indirectly coupling a spring to said first end and said body, such that when said chain segment is tightened around said pipe, said spring is
(A) operable to expand when additional force is added pulling said first end away from said body and
(B) operable to compress when the force pulling said first end from said body is decreased.

6. The method of claim 3, wherein said chain segment defines an elliptical helix when said pipe is elliptical.

7. The method of claim 3, wherein said chain segment defines a conic helix when said pipe is conical.

8. The method of claim 3, further comprising:
(A) coupling a grip to said body, and
(B) pushing said grip in a direction tangential to the outer circumference of said pipe.

9. The method of claim 3, wherein the width of said blade is greater than the pitch of said substantially helical pattern.

10. A device for peeling a pipe, comprising:
(A) a body;
(B) a blade coupled to said body;
(C) a chain segment, wherein said chain segment includes a first end and a second end; and
(D) a chain tightener;
wherein
(A) said first end of said chain segment is coupled to said body;
(B) said second end of said chain segment is coupled to said body by said chain tightener; and
(C) said chain segment substantially defines a helix when said chain segment is substantially an arc shape.

11. The device of claim 10, further comprising:
(A) a spring, wherein said spring is coupled to said tightener;
(B) two stoppers, wherein said two stoppers are coupled to said tightener, and wherein said spring is between said two stoppers;
wherein said stoppers are operable to compress said spring when said first end is pulled away from said body.

12. The device of claim 10, wherein the width of said blade is greater than one pitch of said helix.
